(19) United States
(12) Patent Application Publication
(10) Pub. No.: US 2013/0201326 A1
(43) Pub. Date: Aug. 8, 2013

(54) SINGLE CAMERA IMAGE PROCESSING APPARATUS, METHOD, AND PROGRAM

(71) Applicant: Hiroshi Tsujii, Kobe (JP)

(72) Inventor: Hiroshi Tsujii, Kobe (JP)

(21) Appl. No.: 13/746,252

(22) Filed: Jan. 21, 2013

Related U.S. Application Data
(60) Provisional application No. 61/589,729, filed on Jan. 23, 2012.

(51) Int. Cl. G01C 11/02

(52) U.S. Cl. CPC G01C 11/02
USPC 348/135

(57) ABSTRACT

An apparatus includes a single camera and a computing terminal, and in the computing terminal, a storage means thereof stores, internal orientation parameters of the camera and actual coordinates of three feature points of a measured object, a data transfer means loads a camera image containing three feature points within a camera field of view, and a computing means performs, on camera view coordinates of the feature points in the loaded image, correction, based on the internal orientation parameters, of distortion in the image, calculates, from the camera view coordinates and the actual coordinates of the distortion-corrected feature points, a camera position and angle in a coordinate system based on the measured object during image capture, and calculates three-dimensional coordinates of the feature points in a camera-based coordinate system using a coordinate transformation with which the calculated camera position and angle during image capture are a reference position and angle.

### TECHNICAL FIELD

The present invention relates to an image measurement art using a single camera.

### BACKGROUND ART

In conventional camera image measurement, a bundle calculation system of calculating a position of an object point by performing a bundle calculation based on images captured from several viewpoints with a single camera or a stereo camera system of performing measurement with two cameras that are fixed in position in advance is used. The bundle calculation system has a problem in that effort is required because the images are captured with numerous targets being attached to a measured object and also a scale bar, etc., is required in a case where a distance, such as a length or interval, etc., is required.

On the other hand, with the stereo camera system, three-dimensional coordinates of a point on the measured object can be made known by designation of corresponding points in two photographs captured from different angles. Corresponding point images in the two photographs appear at different points in the photographs so that a difference (parallax) between positions in the photographs of the respective images can be measured, and a distance, such as a length or interval, etc., can be calculated automatically because the parallax contains distance information.

However, in the case of the stereo camera system, the cameras are fixed and thus an image capturing range is restricted and it is also difficult to capture images freely from any direction. Further in the case of the stereo camera system, the apparatus itself must be prepared separately and there is thus a disadvantage of being high in cost in comparison to the bundle calculation system using a single camera.

There is also known a photogrammetry method with which coordinates of survey points present on the same arbitrary plane positioned on the same plane are calculated from a single camera image (Patent Document 1). With the photogrammetry according to Patent Document 1, a subject is photographed by a camera from a single observation point, distances to three reference points on a specific plane of the subject are measured with a tape measure, etc., and two-dimensional coordinates of any survey point positioned on the specific plane of a component portion of the subject are calculated from a single camera image. This method, with which the reference points and the survey point are present on the same plane and any survey point on the same plane is surveyed in a simplified manner from a single camera image, is known to be suited for surveying of a wall surface of a structure, etc.

However, with the photogrammetry method of Patent Document 1, the reference points and the survey point are required to be present on the same plane and there is thus a problem in that the reference points and the survey point cannot be selected freely. Frequently in cases where photogrammetry of a product having a three-dimensional structure is to be performed with a single camera, the reference points and the survey point are not necessarily present on the same plane, even though there may be exceptions depending on shape characteristics of the product.

Currently with measurement using a single camera, depth information cannot be acquired with good accuracy and inmost cases a laser for distance measurement is used in the single camera. Under such circumstances, there are demands for arts that enable measurement of good accuracy to be performed with a single camera for recognition of a three-dimensional position of an object on a production line or for positioning and tracking of an object, etc.
[Patent Document 1] JP-A-2003-177017

### OUTLINE OF THE INVENTION

### Problems to be Solved by the Invention

In view of the above circumstances, an object of the present invention is to provide an image measurement processing apparatus, an image measurement processing method, and an image measurement processing program that enable three-dimensional position coordinates of a feature point on a measured object to be made known with good accuracy with a single camera.

### Means to Solve the Objects

To achieve the above object, a single camera image measurement processing apparatus according to a first aspect of the present invention includes

(1) a single camera means and

(2) an information computing terminal including at least a computing means, a storage means, and a data transfer means, and

the information computing terminal of (2) is arranged so that

A) the storage means

stores, in advance, calculated internal orientation parameters of the camera means and actual coordinates of at least four feature points of a measured object (with any three of the four points not being present on a single straight line),

B) the data transfer means

loads an image captured using the camera means and containing four of the feature points within a camera field of view, and

C) the computing means

C-1) performs, on camera view coordinates of the feature points in the loaded image, correction, based on the internal orientation parameters, of distortion in the image,

C-2) calculates, from the camera view coordinates and the actual coordinates of the distortion-corrected feature points, a camera position and a camera angle in a coordinate system based on the measured object during image capture, and

C-3) calculates three-dimensional coordinates of the feature points in a camera-based coordinate system using a coordinate transformation with which the calculated camera position and camera angle during image capture are a reference position and a reference angle.

With the present arrangement, three-dimensional position coordinates of the feature points on the measured object can be acquired with good accuracy using a single camera.

Here, as the camera means of (1), a commercially available digital camera, measurement camera, or digital video camera may be used. With the camera means, camera calibration must be performed to analytically determine a camera state when a camera image is captured. Specifically, camera calibration refers to determining external orientation parameters, such as a position and an attitude (camera angle) of the camera during image capture, and internal orientation parameters, such as a focal distance, deviation of principal point position, and lens distortion coefficients, in advance.

Here, the camera position and the camera angle during image capture, which are the external orientation parameters, depend on actual, on-site image capturing circumstances of the camera and are thus automatically calculated from the acquired image.

Also, the internal orientation parameters are the following internal parameters a) to d) and these are stored in advance in the storage means of the information computing terminal.

### a) Focal Distance

This value is calculated as a distance from a lens center (principal point) of the camera to an image capture surface (CCD sensor, etc.) at an accuracy, for example, of 0.1 microns.

### b) Deviation of Principal Point Position

This refers to deviation amounts of the principal point of the camera with respect to a central position of the image capture surface in respective directions along two planar axes (x and y) and depends on accuracy of assembly during manufacture of the camera, and the values are calculated at an accuracy, for example, of 0.1 microns.

### c) Radial Lens Distortion Correction Coefficient

In image capture by a digital camera, light is received by a planar image capture surface through a lens with a curved surface so that a distortion that increases with distance away from the center occurs in each pixel on a captured image, and thus a coefficient for correcting such a distortion is calculated.

### d) Tangential Lens Distortion Correction Coefficient

A tangential lens distortion occurs due to the lens and the image capture surface not being installed in parallel and a correction coefficient is calculated because the distortion is dependent on the accuracy of assembly during camera manufacture.

Also, the information computing terminal of (2) may be arranged from a desktop computer, a laptop computer, a handheld computer, or a PDA (personal digital assistant) or other mobile computer. The storage means may be arranged from a RAM (volatile memory) or a PROM (writable memory), etc.

Also, the data transfer means of the information computing terminal is not restricted to that which, like a USB interface, is connected to the camera means by a wire cable to transfer image data and may be that with which image data are transferred by infrared data transfer or other form of wireless communication.

With the single camera image measurement processing apparatus according to the present invention, the three-dimensional position coordinates of four of the feature points of the measured object are converted into coordinates of the camera-based coordinate system, that is, coordinates as viewed from the camera position of the reference coordinates by means of C-1) to C-3) described above.

Based on the internal orientation parameters, the camera view coordinates, which are two-dimensional coordinates of the feature points in the loaded camera image, are corrected for distortion in the image, and thereafter, the camera position and the camera angle in the coordinate system based on the measured object are calculated from the camera view coordinates (two-dimensional coordinates) and the actual coordinates (three-dimensional coordinates of the measured object that are stored in advance in the A) storage means) of the distortion-corrected feature points.

Here, the actual coordinates of at least four feature points are stored in advance, and it is required that any three of the four feature points are not present on a single straight line.

Next, in order to convert the three-dimensional position coordinates of four of the feature points of the measured object into the camera-based coordinate system, a coordinate transformation matrix, with which the calculated camera position and camera angle during image capture are the reference position and the reference angle, is used to calculate the three-dimensional coordinates of the feature points in the camera-based coordinate system.

Also preferably, the single camera image measurement processing apparatus according to the present invention is arranged so that at least two images, each captured by the camera means and containing four of the feature points within the camera field of view, are loaded and a movement amount of the measured object is calculated from the three-dimensional coordinates of the feature points in the camera-based coordinate system.

With this arrangement, the movement amounts of the feature points of the measured object can be detected by continuous calculation of the three-dimensional coordinates of the feature point of the measured object in the camera-based coordinate system from the two or more camera images captured by the single camera.

Also, a single camera image measurement processing apparatus according to a second aspect of the present invention includes

at least the two camera means of a first camera means and a second camera means and

an information computing terminal including at least a computing means, a storage means, and a data transfer means, and

the information computing terminal is arranged so that

the storage means

stores, in advance, calculated first internal orientation parameters of the first camera means, second internal orientation parameters of the second camera means, actual coordinates of at least four feature points of a measured object (with any three of the four points not being present on a single straight line), and a relative positional relationship of the first camera means and the second camera means,

the data transfer means

loads an image captured using the first camera means and containing a first feature point set of four points within a camera field of view and an image captured using the second camera means and containing a second feature point set of four points within a camera field of view, and

the computing means

performs, on camera view coordinates of the first feature point set and the second feature point set in the loaded images, correction, based on the internal orientation parameters, of distortions in the images,

calculates, from the distortion-corrected camera view coordinates and the actual coordinates of the first feature point set and the second feature point set, camera positions and camera angles in coordinate systems based on the measured object during the respective image captures by the first camera means and the second camera means, and calculates three-dimensional coordinates of the feature points in camera-based coordinate systems using coordinate transformations with each of which the calculated camera position and camera angle during image capture are a reference position and a reference angle.

In a case of a stereo camera system, the two stereoscopically positioned cameras must capture the same feature points within the camera fields of view in order for the two cameras to acquire depth information in accordance with principles of triangulation.

With the single camera image measurement process according to the present invention, the three-dimensional position coordinates of all feature points on the measured object in the camera-based coordinate system can be acquired as long as no less than four feature points of the measured object can be acquired with the single camera, and therefore even in a case where four points that are all different are captured in the camera field of view of each of two cameras, the three-dimensional position coordinates of all feature points of the measured object in the camera-based coordinate system can be acquired for each of the cameras.

Therefore, for example, by using two cameras at a right side and a left side of a manufacturing line for automobiles to simultaneously capture a right side surface and a left side surface and calculating the three-dimensional position coordinates of four feature points of the right side surface and four feature points of the left side surface, which all differ from the four feature points of the right side surface, an interval distance and a positional relationship between a feature point on the right side surface and a feature point on the left side surface can be obtained.

Next, a single camera image measurement processing method according to a first aspect of the present invention includes the following step 1 to step 6.

(Step 1) a step of reading actual coordinate data of at least four feature points of a measured object (with any three of the four points not being present on a single straight line),
(Step 2) a step of reading internal orientation parameters of a camera means,
(Step 3) a step of loading an image captured using the camera means and containing four of the feature points within a camera field of view,
(Step 4) a step of performing, on camera view coordinates of the feature points in the loaded image, correction, based on the internal orientation parameters, of distortion in the image,
(Step 5) a step of calculating, from the camera view coordinates and the actual coordinates of the distortion-corrected feature points, a camera position and a camera angle in a coordinate system based on the measured object during image capture, and
(Step 6) a step of calculating three-dimensional coordinates of the feature points in a camera-based coordinate system using a coordinate transformation with which the calculated camera position and camera angle during image capture are a reference position and a reference angle.

With the arrangement including step 1 to step 6, the three-dimensional position coordinates of at least four feature points of the measured object can be acquired by conversion into the three-dimensional coordinates in the camera-based coordinate system.

Here, the single camera image measurement processing method according to the present invention preferably includes a step 7 in addition to the above step 1 to step 6.

(Step 7) A step of loading at least two images, each captured using the camera means and containing four of the feature points within the camera field of view, and calculating a movement amount of the measured object from the three-dimensional coordinates of the feature points in the camera-based coordinate system.

With the arrangement including step 7, the movement amounts of the feature points of the measured object can be detected by continuous calculation of the three-dimensional coordinates of the feature points of the measured object in the camera-based coordinate system from the two or more camera images captured by the single camera.

Next, a single camera image measurement processing program according to a first aspect of the present invention makes a computer execute the following procedure 1 to procedure 7.

(Procedure 1) a procedure of reading actual coordinate data of at least four feature points of a measured object (with any three of the four points not being present on a single straight line),
(Procedure 2) a procedure of reading internal orientation parameters of a camera means,
(Procedure 3) a procedure of loading an image captured using the camera means and containing four of the feature points within a camera field of view,
(Procedure 4) a procedure of performing, on camera view coordinates of the feature points in the loaded image, correction, based on the internal orientation parameters, of distortion in the image,
(Procedure 5) a procedure of calculating, from the camera view coordinates and the actual coordinates of the distortion-corrected feature points, a camera position and a camera angle in a coordinate system based on the measured object during image capture,
(Procedure 6) a procedure of repeating the above (Procedure 3) to (Procedure 5), and
(Procedure 7) a procedure of calculating three-dimensional coordinates of the feature points in a camera-based coordinate system using a coordinate transformation with which the calculated camera position and camera angle during image capture are a reference position and a reference angle.

With the arrangement including procedure 1 to procedure 7, the three-dimensional position coordinates of at least four feature points of the measured object can be acquired upon conversion into the three-dimensional coordinates in the camera-based coordinate system.

Here, the single camera image measurement processing program according to the present invention preferably makes the computer further execute a procedure 8 in addition to the above procedure 1 to procedure 7.

(Procedure 8) A procedure of loading at least two images, each captured using the camera means and including four of the feature points within the camera field of view, and calculating a movement amount of the measured object from the three-dimensional coordinates of the feature points in the camera-based coordinate system.

With the arrangement including procedure 8, the movement amounts of the feature points of the measured object can be detected by continuous calculation of the three-dimensional coordinates of the feature points of the measured object in the camera-based coordinate system from the two or more camera images captured by the single camera.

Also, a single camera image measurement processing apparatus according to a third aspect of the present invention includes

a single camera means, a measuring probe, and an information computing terminal including at least a computing means, a storage means, and a data transfer means, and

the information computing terminal is arranged so that

the storage means

stores, in advance, calculated internal orientation parameters of the camera means, actual coordinates of four feature points of the measuring probe (with any three of the four points not being present on a single straight line), and actual coordinates of a probe tip portion of the measuring probe,

the data transfer means

loads an image captured using the camera means and containing the four feature points within a camera field of view, and

the computing means

performs, on camera view coordinates of the feature points in the loaded image, correction, based on the internal orientation parameters, of distortion in the image,

calculates, from the camera view coordinates and the actual coordinates of the distortion-corrected feature points, a camera position and a camera angle in a coordinate system based on the measuring probe during image capture, and calculates three-dimensional coordinates of the feature points in a camera-based coordinate system using a coordinate transformation with which the calculated camera position and camera angle during image capture are a reference position and a reference angle, and

obtains the three-dimensional position coordinates of a measured object in the camera-based coordinate system by making the probe tip portion of the measuring probe contact the measured object.

With the present arrangement, the positions of the four feature points serving as references of the measuring probe are measured and the position of the tip portion of the measuring probe is determined by calibration to obtain a positional relationship of the four points serving as references and the probe tip portion, and the three-dimensional position coordinates of the measured object can thus be calculated by making the probe tip portion contact the measured portion.

As a calibration method, a method of measuring a circumference of a sphere or a method of direct measurement by a three-dimensional measuring apparatus may be used.

Also, a single camera image measurement processing apparatus according to a fourth aspect of the present invention includes

a single camera means, a measuring probe irradiating point laser light to perform non-contact measurement, and an information computing terminal including at least a computing means, a storage means, and a data transfer means, and

the information computing terminal is arranged so that

the storage means

stores, in advance, calculated internal orientation parameters of the camera means, actual coordinates of four feature points of the measuring probe (with any three of the four points not being present on a single straight line), and a direction vector of the point laser light of the measuring probe obtained from actual coordinates of two points on the point laser light,

the data transfer means

loads an image captured using the camera means and containing, within a camera field of view, the four feature points and a portion of a measured object irradiated by the point laser light of the measuring probe, and

the computing means

performs, on camera view coordinates of the feature points in the loaded image, correction, based on the internal orientation parameters, of distortion in the image,

calculates, from the camera view coordinates and the actual coordinates of the distortion-corrected feature points, a camera position and a camera angle in a coordinate system based on the measuring probe during image capture, calculates three-dimensional coordinates of the feature points in a camera-based coordinate system using a coordinate transformation with which the calculated camera position and camera angle during image capture are a reference position and a reference angle, and

obtains the three-dimensional position coordinates in the camera-based coordinate system of the portion of the measured object irradiated by the point laser light of the measuring probe.

With the present arrangement, the positions of the four feature points serving as references of the measuring probe are measured, the positions of the two points of arbitrary distance on the point laser light are determined by calibration, the direction vector of the point laser light is acquired, and the three-dimensional position coordinates in the camera-based coordinate system of the portion of the measured object irradiated by the point laser light can be calculated without making the probe tip portion contact the measured portion.

Also, a single camera image measurement processing apparatus according to a fifth aspect of the present invention includes

a single camera means, a measuring probe irradiating line laser light to perform non-contact measurement, and an information computing terminal including at least a computing means, a storage means, and a data transfer means, and

the information computing terminal is arranged so that

the storage means

stores, in advance, calculated internal orientation parameters of the camera means, actual coordinates of four feature points of the measuring probe (with any three of the four points not being present on a single straight line), and a formula of a plane of the line laser light of the measuring probe obtained from actual coordinates of three points (with the three points not being present on a single straight line) on the line laser light,

the data transfer means

loads an image captured using the camera means and containing, within a camera field of view, the four feature points and a continuous line of laser light appearing on a surface of a measured object due to irradiation of the line laser light of the measuring probe, and

the computing means

performs, on camera view coordinates of the feature points in the loaded image, correction, based on the internal orientation parameters, of distortion in the image,

calculates, from the camera view coordinates and the actual coordinates of the distortion-corrected feature points, a camera position and a camera angle in a coordinate system based on the measuring probe during image capture, calculates three-dimensional coordinates of the feature points in a camera-based coordinate system using a coordinate transformation with which the calculated camera position and camera angle during image capture are a reference position and a reference angle, and

obtains the three-dimensional position coordinates in the camera-based coordinate system in regard to a continuous line (set of pixels) that appears when the line laser light of the measuring probe is irradiated onto the measured object.

With the present arrangement, the positions of the four feature points serving as references of the measuring probe are measured, the positions of the three arbitrary points on the line laser light are determined by calibration, the formula of the plane of the line laser light is acquired, and the three-dimensional position coordinates in the camera-based coordinate system can be calculated in regard to the continuous line (set of pixels) appearing upon irradiation of the line laser light without making the probe tip portion contact the measured portion.

Also, a single camera image measurement processing apparatus according to a sixth aspect of the present invention includes

a single camera means and an information computing terminal including at least a computing means, a storage means, and a data transfer means, and

the information computing terminal is arranged so that

the storage means

stores, in advance, calculated internal orientation parameters of the camera means and distance-between-points data of three feature points of a measured object (with the three points being present on a single straight line),

the data transfer means

loads an image captured using the camera means and containing the three feature points within a camera field of view, and

the computing means

performs, on camera view coordinates of the feature points in the loaded image, correction, based on the internal orientation parameters, of distortion in the image, and

calculates, from the camera view coordinates of the distortion-corrected feature points and the distance-between-points data of the three feature points, three-dimensional coordinates of the three feature points in a camera-based coordinate system.

As a result of repeating research and experiments, the present inventor found that measurement can be made at high accuracy using a bar having three feature points that are present on a single straight line (the bar having the three feature points present on the single straight line shall hereinafter be referred to as the “reference bar”). Although there are methods of performing measurement using three feature points that have been discussed in the field of the art from before, the current circumstances are such that practical application as a measurement device is yet to be achieved due to problems of accuracy and problems of not being able to determine a solution. It is also a fact that the introduction of the stereo camera has inhibited development of a measurement device that performs measurements using three feature points.

However, the ability to perform three-dimensional measurements of a measured object using three feature points provides tremendous merits. That is, as a first merit, an amount of calculation is low and processing can be performed at high speed because calculation is performed with three feature points. Consequently, it is possible to perform measurements from a still image, such as a photograph, as well as perform moving image measurements using a video camera. Also as a second merit, with three feature points, a rod-like index device can be arranged. The environment for measurement is not necessarily good at an actual site, such as a building construction site, etc. An ability to readily carry the device into such a site is also an important element. Further, as a third merit, even objects of large scale can be measured. For example, with a large-scale building, measurement of approximately several dozen meters is required. In this case, two of the abovementioned reference bars are prepared and respectively disposed at respective ends of the large-scale building to measure the building.

Also, a single camera image measurement processing method according to a second aspect of the present invention includes the following step 1 to step 6 and enables measurements to be made at high speed and good accuracy.

(Step 1) a step of reading distance-between-points data of three feature points of a measured object (with the three points being present on a single straight line),
(Step 2) a step of reading internal orientation parameters of a camera means,
(Step 3) a step of loading an image captured using the camera means and containing the three feature points within a camera field of view,
(Step 4) a step of performing, on camera view coordinates of the feature points in the loaded image, correction, based on the internal orientation parameters, of distortion in the image, and
(Step 5: three-point-on-single-straight-line actual coordinate calculating step) a step of calculating, from the camera view coordinates of the distortion-corrected feature points and the distance-between-points data of the three feature points, three-dimensional coordinates of the three feature points in a camera-based coordinate system.

Also, a single camera image measurement processing program according to a second aspect of the present invention makes a computer execute the following procedure 1 to procedure 6 to enable processing to be performed at high speed and measurement to be made with good accuracy.

(Procedure 1) a procedure of reading distance-between-points data of three feature points of a measured object (with the three points being present on a single straight line),
(Procedure 2) a procedure of reading internal orientation parameters of a camera means,
(Procedure 3) a procedure of loading an image captured using the camera means and containing the three feature points within a camera field of view,
(Procedure 4) a procedure of performing, on camera view coordinates of the feature points in the loaded image, correction, based on the internal orientation parameters, of distortion in the image,
(Procedure 5) a procedure of calculating, from the camera view coordinates of the distortion-corrected feature points and the distance-between-points data of the three feature points, three-dimensional coordinates of the three feature points in a camera-based coordinate system, and
(Procedure 6) a procedure of repeating the above (Procedure 3) to (Procedure 5).

Also, a single camera image measurement processing apparatus according to a seventh aspect of the present invention includes

a single camera means and an information computing terminal including at least a computing means, a storage means, and a data transfer means, and

the information computing terminal is arranged so that

the storage means

stores, in advance, calculated internal orientation parameters of the camera means and distance-between-points data of three feature points of a measured object (with the three points not being present on a single straight line),

the data transfer means

loads an image captured using the camera means and containing the three feature points within a camera field of view, and

the computing means

performs, on camera view coordinates of the feature points in the loaded image, correction, based on the internal orientation parameters, of distortion in the image and

calculates, from the camera view coordinates of the distortion-corrected feature points and the distance-between-points data of the three feature points, three-dimensional coordinates of the three feature points in a camera-based coordinate system.

As a result of repeating research and experiments, the present inventor made a finding that even when three feature points that are not present on a single straight line are used, a single solution is determined and a three-dimensional measurement can be made with good accuracy.

A single camera image measurement processing method according to a third aspect of the present invention includes the following step 1 to step 6 and enables measurements to be made at high speed and good accuracy.

(Step 1) a step of reading distance-between-points data of three feature points of a measured object (with the three points not being present on a single straight line),
(Step 2) a step of reading internal orientation parameters of a camera means,
(Step 3) a step of loading an image captured using the camera means and containing the three feature points within a camera field of view,
(Step 4) a step of performing, on camera view coordinates of the feature points in the loaded image, correction, based on the internal orientation parameters, of distortion in the image, and
(Step 5: three-point actual coordinate calculating step) a step of calculating, from the camera view coordinates of the distortion-corrected feature points and the distance-between-points data of the three feature points, three-dimensional coordinates of the three feature points in a camera-based coordinate system.

Also, a single camera image measurement processing program according to a third aspect of the present invention makes a computer execute the following procedure 1 to procedure 6 to enable processing to be performed at high speed and measurement to be made with good accuracy.

(Procedure 1) a procedure of reading distance-between-points data of three feature points of a measured object (with the three points not being present on a single straight line),
(Procedure 2) a procedure of reading internal orientation parameters of a camera means,
(Procedure 3) a procedure of loading an image captured using the camera means and containing the three feature points within a camera field of view,
(Procedure 4) a procedure of performing, on camera view coordinates of the feature points in the loaded image, correction, based on the internal orientation parameters, of distortion in the image,
(Procedure 5) a procedure of calculating, from the camera view coordinates of the distortion-corrected feature points and the distance-between-points data of the three feature points, three-dimensional coordinates of the three feature points in a camera-based coordinate system, and
(Procedure 6) a procedure of repeating the above (Procedure 3) to (Procedure 5).

The single camera image measurement processing program of each of the second aspect and third aspect described above is fast in processing, enables moving image measurements, and is thus preferably installed in a video camera.

### Effects of the Invention

By the single camera image measurement processing apparatus, image measurement processing method, and image measurement processing program according to the present invention, the three-dimensional position coordinates of a feature point on a measured object can be made known with good accuracy using a single camera.

### BRIEF DESCRIPTION OF THE DRAWINGS

FIG. 1 is a conceptual diagram of an image measurement processing apparatus of Example 1.

FIG. 2 is a block diagram of the image measurement processing apparatus of Example 1.

FIG. 3 is a process flow diagram of the image measurement processing apparatus of Example 1.

FIG. 4 is an explanatory diagram 1 of a process flow of the image measurement processing apparatus of Example 1.

FIG. 5 is an explanatory diagram 2 of a process flow of the image measurement processing apparatus of Example 1.

FIG. 6 is an explanatory diagram 3 of a process flow of the image measurement processing apparatus of Example 1.

FIG. 7 is a layout diagram of measurement targets in Accuracy Verification Experiment 1 and Accuracy Verification Experiment 2.

FIG. 8 is a layout diagram of measurement targets in Accuracy Verification Experiment 3.

FIG. 9 is an explanatory diagram of a contacting type probe.

FIG. 10 is an explanatory diagram of a point laser light non-contacting type probe.

FIG. 11 is an explanatory diagram of an image measurement processing apparatus using a point laser light non-contacting type probe.

FIG. 12 is an explanatory diagram of a line laser light non-contacting type probe.

FIG. 13 is an explanatory diagram of an image measurement processing apparatus using a line laser light non-contacting type probe.

FIG. 14 is a measurement concept diagram of Example 5.

FIG. 15 is an explanatory diagram of a calculation method in a case where three points lie on a single straight line in Example 5.

FIG. 16 is a measurement concept diagram of Example 6.

FIG. 17 is an explanatory diagram of a calculation method in a case where three points are not present on a straight line in Example 6.

FIG. 18 is a layout diagram of measurement targets in Accuracy Verification Experiment 4.

FIG. 19 is a layout diagram of measurement targets in Accuracy Verification Experiment 5.

FIG. 20 shows actual coordinates calculated by processes of Example 5 (Accuracy Verification Experiment 4).

FIG. 21 shows actual coordinates calculated by processes of Example 6 (Accuracy Verification Experiment 4).

FIG. 22 shows actual coordinates calculated by processes of Example 5 (Accuracy Verification Experiment 5).

### BEST MODE FOR CARRYING OUT THE INVENTION

Embodiments of the present invention will be described in detail below with reference to the drawings. The present invention is not limited to the following embodiment and examples of shown in the figure, and the present invention can be variously changed in design.

### Embodiment 1

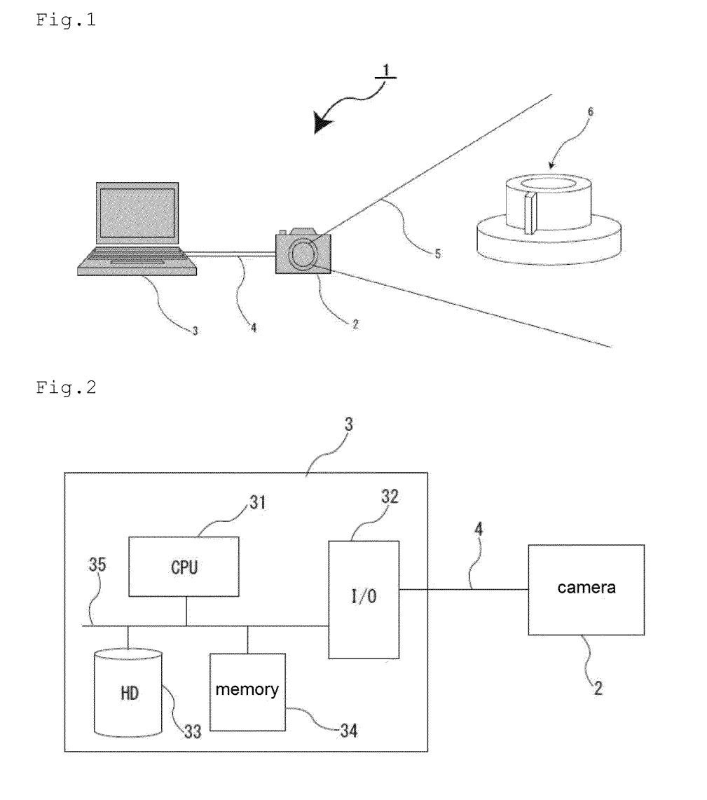

FIG. 1 is a conceptual diagram of a single camera image measurement processing apparatus of Example 1. With the single camera image measurement processing apparatus 1 of Example 1, a single digital camera 2 and a laptop personal computer that is an information computing terminal 3 are connected by a data transfer cable 4, and as shown in FIG. 1, a measured object 6 with a three-dimensional shape is captured in a camera field of view 5 to determine three-dimensional position coordinates of the object as viewed from a camera position.

As shown in FIG. 2, which is a block diagram of the image measurement processing apparatus, the information computing terminal 3 has an arrangement in which a central processing unit (CPU) 31 that is a computing means, a memory 33 and a hard disk (HD) 34 that are storage means, and an input/output control portion (I/O) 32 that is a data transfer means are connected to an internal bus 35.

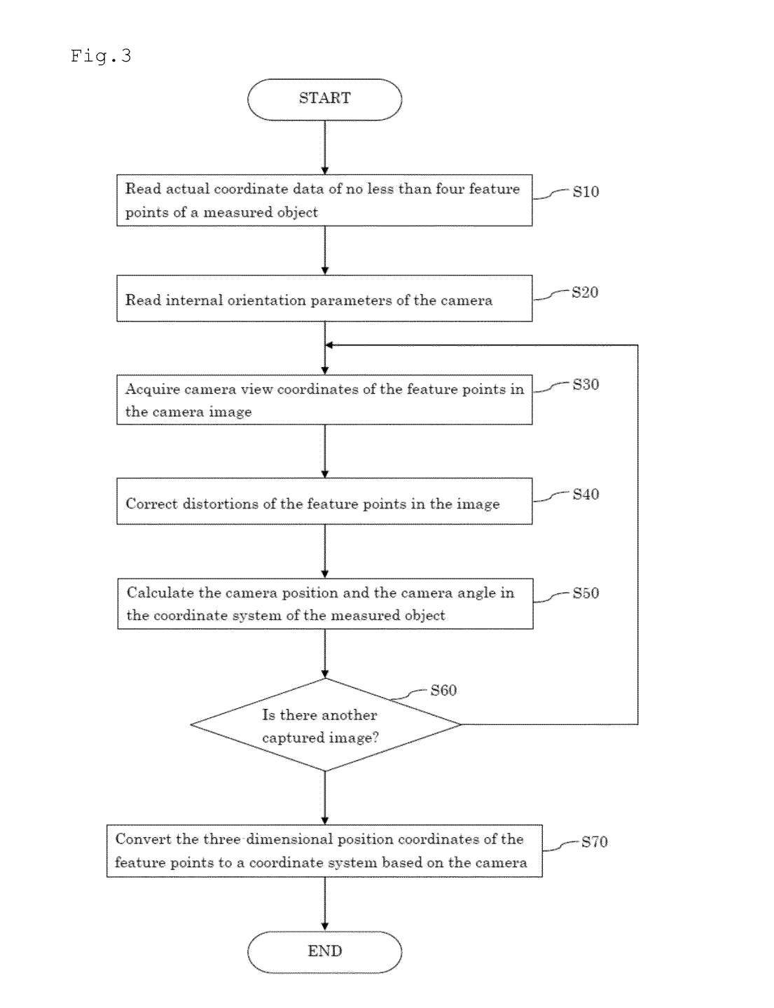

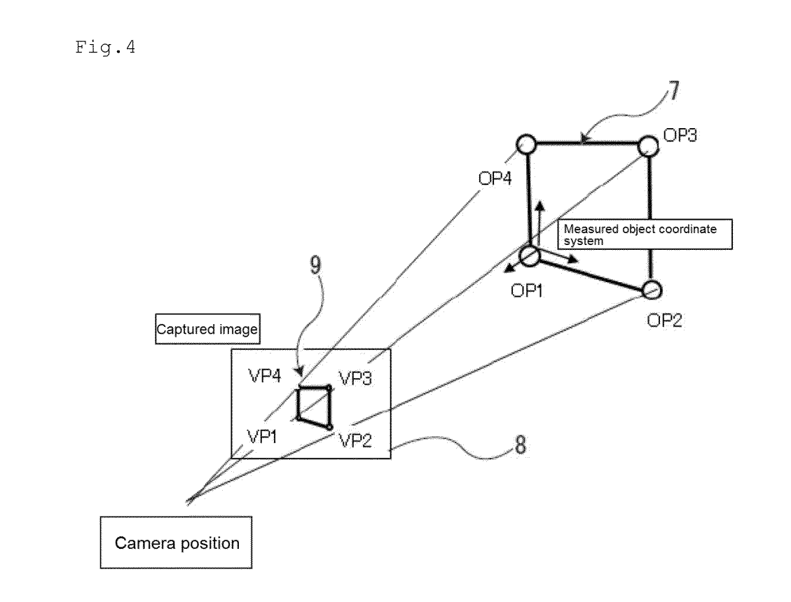

Processes of the single camera image measurement processing apparatus of Example 1 shall now be described. FIG. 3 is a process flow diagram of the image measurement processing apparatus. Also, FIGS. 4 to 6 are schematic views for explaining the respective processes.

First, actual coordinates of no less than four feature points of the measured object are acquired in advance and these are stored as a data base in the hard disk of the information computing terminal 3. When actually performing the image measurement processing, the data of the actual coordinates of the no less than four feature points of the measured object are read (S10). For example, the known three-dimensional position coordinates of four feature points ((OP1, OP2, OP3, and OP4) of a measured object 7, such as shown in FIG. 4, are read.

Thereafter, internal orientation parameters (camera parameters) that have been measured in advance for distortion correction of a camera image are read from the hard disk (HD) (S20), and camera view coordinates (VP1, VP2, VP3, and VP4), which are two-dimensional coordinates of the feature points in the camera image, are acquired (S30). Correction of distortion in the image of the feature points captured in the camera image is then performed using the camera parameters (S40).

Thereafter, a camera position and a camera angle based on the measured object, that is, the camera position and the camera angle in a measured object coordinate system are calculated (S50). That is, the camera position and the camera angle are calculated from the camera view coordinates (VP1, VP2, VP3, and VP4) of the measured object and the three-dimensional position coordinates (OP1, OP2, OP3, and OP4) of the measured object as shown in FIG. 4. If there is another captured image, the processes of (S30) to (S50) are repeated (S60).

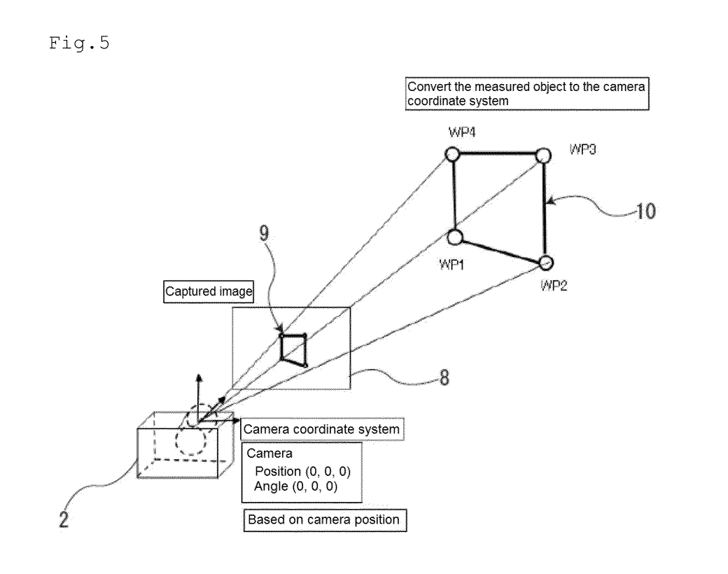

A coordinate transformation matrix is then determined such that the determined camera position and camera angle are camera-based (position (0, 0, 0) angle (0, 0, 0)). The three-dimensional position coordinates of the measured object are then multiplied by the matrix to determine coordinate values (WP1, WP2, WP3, and WP4) that have been converted into the camera-based coordinate system as shown in FIG. 5 (S70).

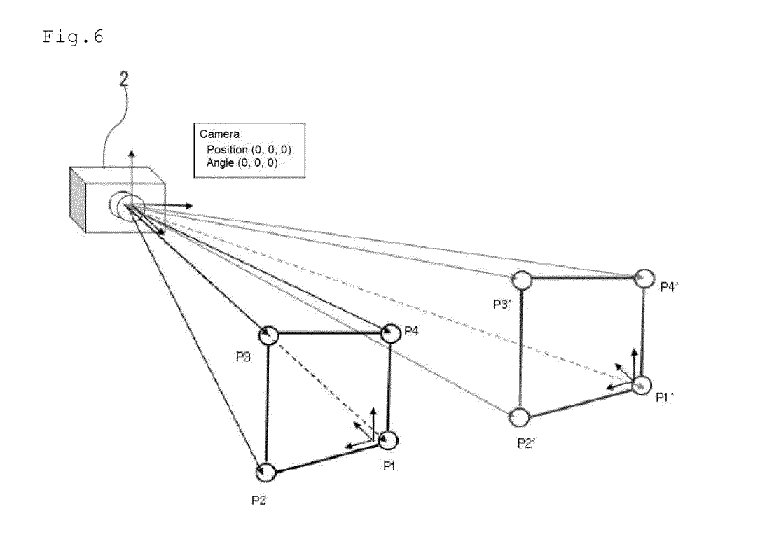

The camera-based three-dimensional position coordinates of the measured object can be calculated as described above, and thus by repeating these processes as shown in FIG. 6, the three-dimensional position coordinates of the measured object can be calculated in a continuous manner and a movement amount of the measured object can also be detected from the single camera.

Accuracy verification experiments of the single camera image measurement processing apparatus of Example 1 shall now be described. Each of the accuracy verification experiments was performed upon positioning eight retroreflective targets. First, four targets at each of right and left sides were handled as a set and positional relationships were measured independently for each set in advance. One of the four targets at each of the right and left sides was attached to both ends of a scale bar of known length. A dimension of the scale bar was then calculated from the three-dimensional position coordinates of the two sets of targets and compared with an actual dimension of the scale bar. The camera used for the experiment has 12 million pixels, and in regard to lens distortion, the internal orientation parameters calculated in advance by performing calibration were used.

The results of the accuracy verification experiments were as follows.

In Accuracy Verification Experiment 1 and Accuracy Verification Experiment 2, the accuracies in cases of using the same measurement targets and making measurements with cameras differing in the internal orientation parameters (focal distance, distortion coefficients, and deviation of principal point) were checked. Also in Accuracy Verification Experiment 2 and Accuracy Verification Experiment 3, the accuracies incases of using different measurement targets and making measurements by cameras with the same internal orientation parameters (focal distance, distortion coefficients, and deviation of principal point) were checked.

(Accuracy Verification Experiment 1)

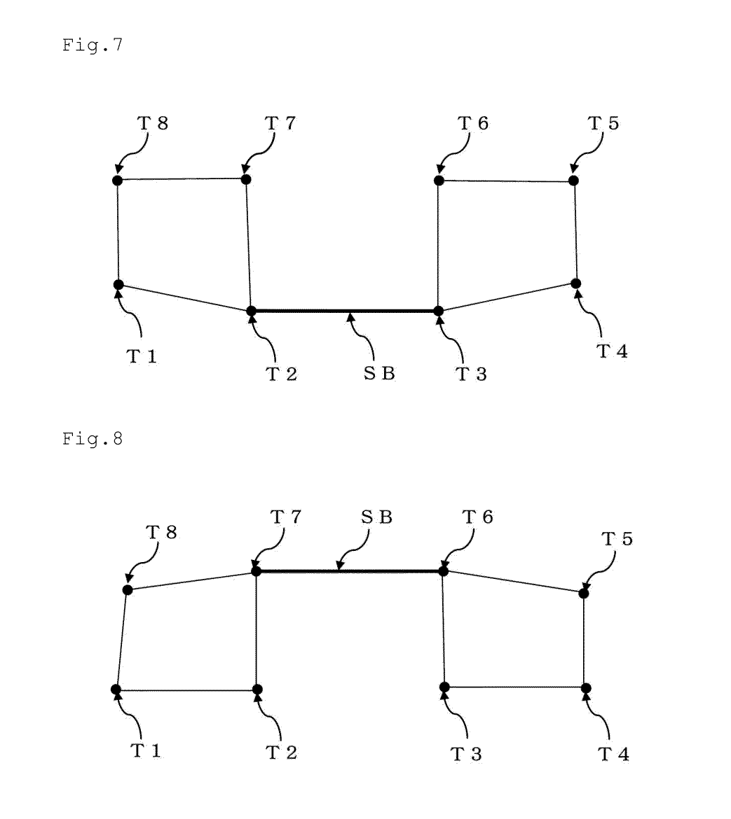

In Accuracy Verification Experiment 1, the measurement targets (feature points T1 to T8) such as shown in FIG. 7 were measured using a camera with the specifications shown below. In Table 1 below, the three-dimensional position coordinates of the measurement targets (feature points T1 to T8) that were measured in advance are indicated as known actual coordinates (x, y, z) of the feature points, and the two-dimensional position coordinates in a single camera image of the measurement targets (feature points T1 to T8) are indicated as camera view coordinates (X, Y). Also in Table 2 below, the results of converting the three-dimensional position coordinates of the measurement targets (feature points T1 to T8) into three-dimensional coordinates in the camera-based coordinate system are indicated as calculated coordinates (x, y, z).

Here, the scale bar of known length is attached between the feature points T6 and T7. The units of length in the Tables are millimeters (mm).

(Camera Specifications)
Model No.: Nikon DX2, number of pixels: 12 million pixels
Internal orientation parameters
a) Focal distance: 24.5414
b) Pixel length: 0.0055
c) Deviation of principal point: xp=0.2033, yp=−0.1395
d) Distortion coefficients:
   Radial
      k1=2.060E-04
      k2=−3.919E-07
      k3=9.720E-10
   Tangential
      p1=2.502E-06
      p2=−2.240E-05

TABLE 1

| | | |
|---|---|---|
| | Camera view | Known actual coordinates |
| Feature | coordinates | of the feature points |

| points | X | Y | x | y | z |
|---|---|---|---|---|---|
| T1 | 744.91 | 1828.25 | 0.000 | 0.000 | 0.000 |
| T2 | 1523.37 | 1826.83 | 402.014 | 0.000 | 0.000 |
| T7 | 1531.74 | 788.17 | 396.310 | 486.267 | −29.801 |
| T8 | 681.18 | 810.71 | 20.193 | 495.823 | 0.000 |
| T3 | 2809.08 | 1811.30 | 497.786 | 0.000 | 0.000 |
| T4 | 3761.69 | 1782.00 | 484.828 | 450.413 | 10.076 |
| T5 | 3728.61 | 758.70 | −0.528 | 439.331 | 0.000 |
| T6 | 2802.17 | 770.90 | 0.000 | 0.000 | 0.000 |

TABLE 2

| Feature | Calculated coordinates | | |
|---|---|---|---|
| points | x | y | z |
| T1 | −692.125 | −182.817 | −2124.363 |
| T2 | −314.733 | −180.699 | −2128.084 |
| T3 | 301.463 | −173.733 | −2132.802 |
| T4 | 749.487 | −157.766 | −2086.318 |
| T5 | 734.795 | 327.598 | −2085.709 |
| T6 | 296.897 | 323.891 | −2120.968 |
| T7 | −309.852 | 315.418 | −2118.515 |
| T8 | −710.084 | 302.309 | −2083.052 |

TABLE 3

| | Scale bar | | |
|---|---|---|---|
| | Actual | | |
| | dimension value | Measured value | Error |
| Distance between the | 606.800 | 606.813 | 0.013 |
| feature points T6 and T7 | | | |

As shown in Table 3 above, in regard to the distance between the feature points T6 and T7, which is the length of the scale bar, the error between the actual dimension value and the measured value is approximately 13 microns and this corresponds to an error of approximately 0.002%. It can thus be understood that the single camera image measurement processing apparatus according to the present invention is extremely high in accuracy.

(Accuracy Verification Experiment 2)

In Accuracy Verification Experiment 2, the accuracy in the case of using the same measurement targets as Accuracy Verification Experiment 1 and making measurements with a camera differing from that of Accuracy Verification Experiment 1 in the internal orientation parameters (focal distance, distortion coefficients, and deviation of principal point) was checked.

As in the case of Accuracy Verification Experiment 1, the measurement targets (feature points T1 to T8) such as shown in FIG. 7 were measured in Accuracy Verification Experiment 2 using the camera with the specifications shown below. In Table 4 below, the three-dimensional position coordinates of the measurement targets (feature points T1 to T8) that were measured in advance are indicated as the known actual coordinates (x, y, z) of the feature points, and the two-dimensional position coordinates in a single camera image of the measurement targets (feature points T1 to T8) are indicated as the camera view coordinates (X, Y). Also in Table 5 below, the results of converting the three-dimensional position coordinates of the measurement targets (feature points T1 to T8) into the three-dimensional coordinates in the camera-based coordinate system are indicated as the calculated coordinates (x, y, z).

As in the case of Accuracy Verification Experiment 1, the scale bar of known length is attached between the feature points T6 and T7. The units of length in the Tables are millimeters (mm).

(Camera Specifications)
Model No.: Nikon DX2, number of pixels: 12 million pixels
Internal orientation parameters
a) Focal distance: 28.8870
b) Pixel length: 0.0055
c) Deviation of principal point: xp=0.2112, yp=−0.1325
d) Distortion coefficients:
   Radial
      k1=7.778E-05
      k2=−2.093E-08
      k3=−3.867E-10
   Tangential
      p1=9.584E-06
      p2=−5.908E-06

TABLE 4

| | | |
|---|---|---|
| | Camera view | Known actual coordinates |
| Feature | coordinates | of the feature points |

| points | X | Y | x | y | z |
|---|---|---|---|---|---|
| T1 | 372.16 | 2572.21 | 422.468 | 399.747 | 17.802 |
| T2 | 1450.55 | 2539.58 | 15.129 | 401.218 | 0.000 |
| T7 | 1511.61 | 1629.38 | 0.000 | 0.000 | 0.000 |
| T8 | 539.01 | 1681.10 | 411.874 | 0.000 | 0.000 |
| T3 | 3018.70 | 2475.87 | 360.138 | 399.325 | 62.333 |
| T4 | 4054.09 | 2387.84 | −0.264 | 398.680 | 0.000 |
| T5 | 3861.23 | 1612.13 | 0.000 | 0.000 | 0.000 |
| T6 | 2948.16 | 1602.04 | 377.411 | 0.000 | 0.000 |

TABLE 5

| Feature | Calculated coordinates | | |
|---|---|---|---|
| points | x | y | z |
| T1 | −685.583 | −426.587 | −1967.715 |
| T2 | −278.300 | −415.410 | −1983.202 |
| T3 | 328.549 | −405.774 | −2056.933 |
| T4 | 730.490 | −368.423 | −2030.630 |
| T5 | 722.161 | −72.133 | −2244.916 |
| T6 | 324.127 | −66.819 | −2222.851 |
| T7 | −282.136 | −77.472 | −2199.971 |
| T8 | −693.406 | −99.736 | −2198.657 |

TABLE 6

| | Scale bar | | |
|---|---|---|---|
| | Actual | | |
| | dimension value | Measured value | Error |
| Distance between the | 606.800 | 606.788 | −0.012 |
| feature points T6 and T7 | | | |

As shown in Table 6 above, in regard to the distance between the feature points T6 and T7, which is the length of the scale bar, the error between the actual dimension value and the measured value is approximately 12 microns and this corresponds to an error of approximately 0.002%. It can thus be understood that the single camera image measurement processing apparatus according to the present invention is extremely high in accuracy.

(Accuracy Verification Experiment 1)

In Accuracy Verification Experiment 3, the accuracy in the case of using the measurement targets differing from those of Accuracy Verification Experiment 1 and making measurements with a camera with the same internal orientation parameters (focal distance, distortion coefficients, and deviation of principal point) as that of Accuracy Verification Experiment 2 was checked.

In Accuracy Verification Experiment 3, the measurement targets (feature points T1 to T8) such as shown in FIG. 8 were measured using the camera with the specifications shown below. In Table 7 below, the three-dimensional position coordinates of the measurement targets (feature points T1 to T8) that were measured in advance are indicated as the known actual coordinates (x, y, z) of the feature points, and the two-dimensional position coordinates in a single camera image of the measurement targets (feature points T1 to T8) are indicated as the camera view coordinates (X, Y). Also in Table 8 below, the results of converting the three-dimensional position coordinates of the measurement targets (feature points T1 to T8) into the three-dimensional coordinates in the camera-based coordinate system are indicated as the calculated coordinates (x, y, z). Unlike in Accuracy Verification Experiment 1 and Accuracy Verification Experiment 2, a scale bar of known length is attached between the feature points T2 and T3 in Accuracy Verification Experiment 3. The units of length in the Tables are millimeters (mm).

(Camera Specifications)
Model No.: Nikon DX2, number of pixels: 12 million pixels
Internal orientation parameters
a) Focal distance: 28.8870
b) Pixel length: 0.0055
c) Deviation of principal point: xp=0.2112, yp=−0.1325
d) Distortion coefficients:
   Radial
      k1=7.778E-05
      k2=−2.093E-08
      k3=−3.867E-10
   Tangential
      p1=9.584E-06
      p2=−5.908E-06

TABLE 7

| | | |
|---|---|---|
| | Camera view | Known actual coordinates |
| Feature | coordinates | of the feature points |

| points | X | Y | x | y | Z |
|---|---|---|---|---|---|
| T1 | 540.84 | 1566.03 | 399.961 | 399.894 | −10.51 |
| T2 | 1511.61 | 1629.38 | −15.383 | 444.163 | 0.000 |
| T7 | 1510.36 | 775.10 | 0.000 | 0.000 | 0.000 |
| T8 | 643.13 | 790.34 | 399.986 | 0.000 | 0.000 |
| T3 | 2948.16 | 1602.04 | 396.226 | 444.395 | 8.618 |
| T4 | 3836.65 | 1494.11 | 0.003 | 400.021 | 0.000 |
| T5 | 3676.51 | 739.31 | 0.000 | 0.000 | 0.000 |
| T6 | 2833.40 | 754.08 | 399.944 | 0.000 | 0.000 |

TABLE 8

| Feature | Calculated coordinates | | |
|---|---|---|---|
| points | x | y | z |
| T1 | −698.050 | −50.202 | −2418.808 |
| T2 | −281.460 | −76.046 | −2201.433 |
| T3 | 324.747 | −65.292 | −2223.896 |
| T4 | 718.596 | −20.023 | −2267.130 |
| T5 | 702.536 | 333.203 | −2454.187 |
| T6 | 303.004 | 322.983 | −2439.174 |
| T7 | −310.033 | 310.541 | −2418.808 |
| T8 | −709.793 | 303.265 | −2201.433 |

TABLE 9

| | Scale bar | | |
|---|---|---|---|
| | Actual | | |
| | dimension value | Measured value | Error |
| Distance between the | 606.800 | 606.718 | 0.082 |
| feature points T6 and T7 | | | |

As shown in Table 9 above, in regard to the distance between the feature points T2 and T3, which is the length of the scale bar, the error between the actual dimension value and the measured value is approximately 82 microns and this corresponds to an error of approximately 0.014%. It can thus be understood that the single camera image measurement processing apparatus according to the present invention is extremely high in accuracy.

### Embodiment 2

(A Contacting Type Measuring Probe)

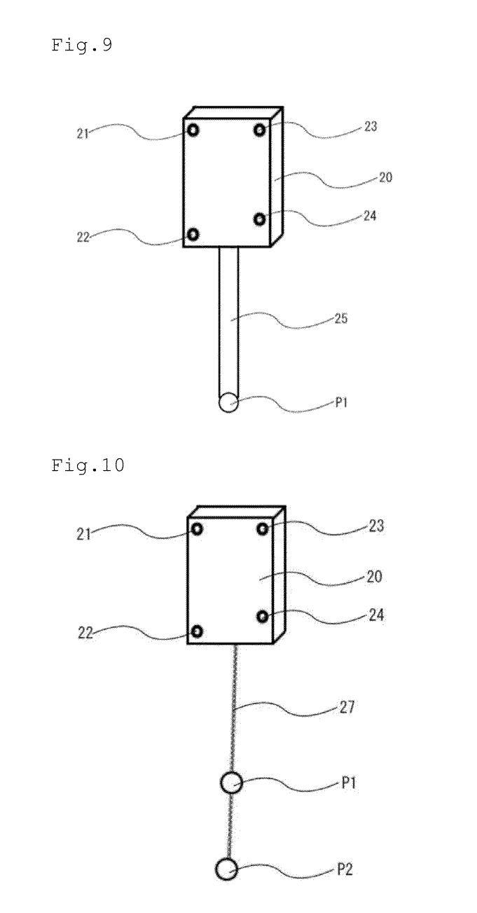

With Example 2, a contacting type probe shall be described. FIG. 9 shows the contacting type probe of Example 2.

In Example 2, the measuring probe shown in FIG. 9 is added to the single camera image measurement processing apparatus of Example 1 described above. The calculated internal orientation parameters of the camera means, the actual coordinates of four feature points (21 to 24) of the measuring probe 20, and the actual coordinates of a probe tip portion (P1) of the measuring probe 20 are stored in advance in the storage means of the information computing terminal of the single camera image measurement processing apparatus of Example 1.

The camera position and the camera angle in a coordinate system based on the measuring probe during image capture are calculated from the camera view coordinates and the actual coordinates of the distortion-corrected feature points, and the three-dimensional coordinates of the feature points in the camera-based coordinate system are calculated using a coordinate transformation with which the calculated camera position and camera angle during image capture are a reference position and a reference angle.

By then putting the tip portion (P1) of aerobe 25 of the measuring probe 20 in contact with a measured object, the three-dimensional position coordinates of the measured object in the camera-based coordinate system are obtained.

### Embodiment 3

(A Point Laser Light Non-Contacting Type Probe)

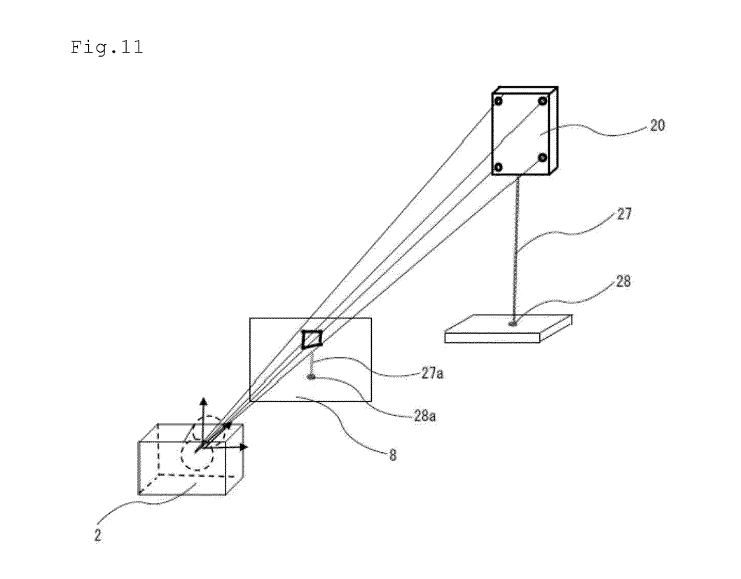

With Example 3, a point laser light non-contacting type probe shall be described. FIG. 10 shows the point laser light non-contacting type probe of Example 3. Also, FIG. 11 is a schematic view of a single camera image measurement processing apparatus using the point laser light non-contacting type probe of Example 3.

In Example 3, the measuring probe 20, which performs measurement in a non-contacting manner by irradiation of point laser light 27 as shown in FIG. 10, is added to the single camera image measurement processing apparatus of Example 1 described above. The calculated internal orientation parameters of the camera 2, the actual coordinates of four feature points (21 to 24) of the measuring probe 20, and a direction vector of the point laser light 27 of the measuring probe 20 obtained from the actual coordinates of two points (P1 and P2) on the point laser light 27 are stored in advance in the storage means of the information computing terminal of the single camera image measurement processing apparatus of Example 1.

Thereafter, as shown in FIG. 11, an image 8, captured using the camera 2 and containing the four feature points (21 to 24) and a portion 28 of a measured object irradiated by the point laser light 27 of the measuring probe 20 in a camera field of view, is loaded.

The camera position and the camera angle in the coordinate system based on the measuring probe 20 during image capture are calculated from the camera view coordinates and the actual coordinates of the distortion-corrected feature points, and the three-dimensional coordinates of the feature points in the coordinate system based on the position of the camera 2 are calculated using a coordinate transformation with which the calculated camera position and camera angle during image capture are the reference position and the reference angle.

Then, for the portion 28 of the measured object that is irradiated by the point laser light 27 of the measuring probe 20, the three-dimensional position coordinates of the measured object in the coordinate system based on the position of the camera 2 are obtained.

### Embodiment 4

(A Line Laser Light Non-Contacting Type Probe)

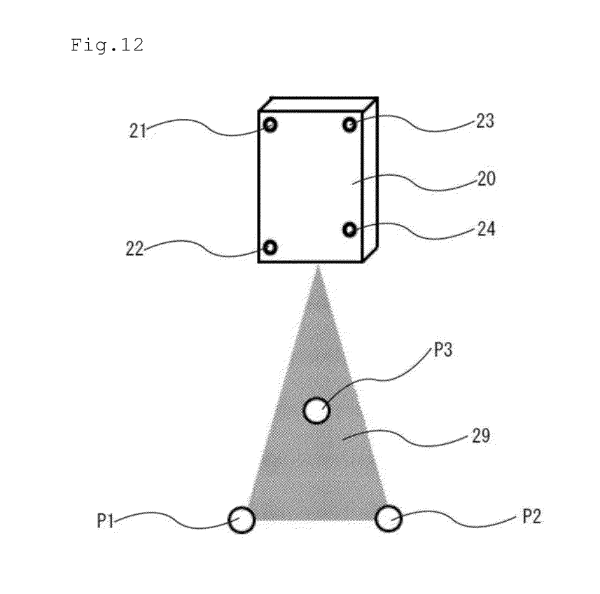

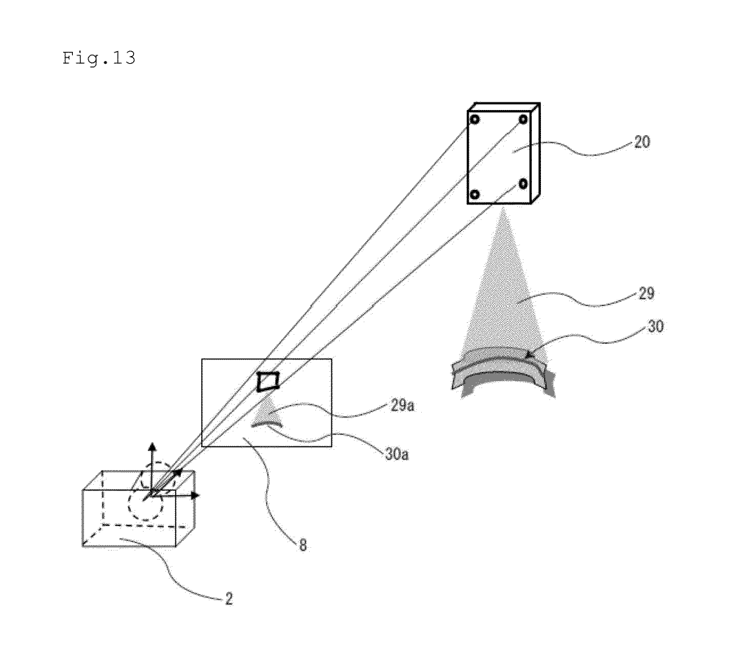

With Example 4, a line laser light non-contacting type probe shall be described. FIG. 12 shows the line laser light non-contacting type probe of Example 4. FIG. 13 is a schematic view of a single camera image measurement processing apparatus using the line laser light non-contacting type probe of Example 4.

In Example 4, the measuring probe 20, which performs measurement in a non-contacting manner by irradiation of line laser light 29 as shown in FIG. 12, is added to the single camera image measurement processing apparatus of Example 1 described above. The calculated internal orientation parameters of the camera means, the actual coordinates of four feature points (21 to 24) of the measuring probe 20, and a formula (ax+by +cz+d=0) of a plane of the line laser light 27 of the measuring probe 20 obtained from the actual coordinates of three points (P1, P2, and P3) on the line laser light 27 are stored in advance in the storage means of the information computing terminal of the single camera image measurement processing apparatus of Example 1.

Thereafter, as shown in FIG. 13, an image 8, captured using the camera 2 and containing, in a camera field of view, the four feature points (21 to 24) and a continuous line 30 of the line laser light 29 appearing on a surface of a measured object due to irradiation by the line laser light 29 of the measuring probe 20, is loaded.

The camera position and the camera angle in the coordinate system based on the measuring probe 20 during image capture are calculated from the camera view coordinates and the actual coordinates of the distortion-corrected feature points, and the three-dimensional coordinates of the feature points in the coordinate system based on the position of the camera 2 are calculated using a coordinate transformation with which the calculated camera position and camera angle during image capture are the reference position and the reference angle.

Then, for the continuous line 30 (set of pixels) that appears upon irradiation of the line laser light 29 of the measuring probe 20 onto the measured object, the three-dimensional position coordinates of the measured object in the coordinate system based on the position of the camera 2 are obtained.

### Embodiment 5

(Three-Dimensional Position Measurement Using Three Feature Points Present on a Single Straight Line)

With Example 5, single camera image measurement processing using a measured object having three feature points present on a single straight line shall be described. The three feature points are deemed to be present on the single straight line. In the single camera image measurement processing using the measured object having the three feature points, the following processes (1) to (4) are performed.

### (1) Distance Data of the Measured Object are Read.

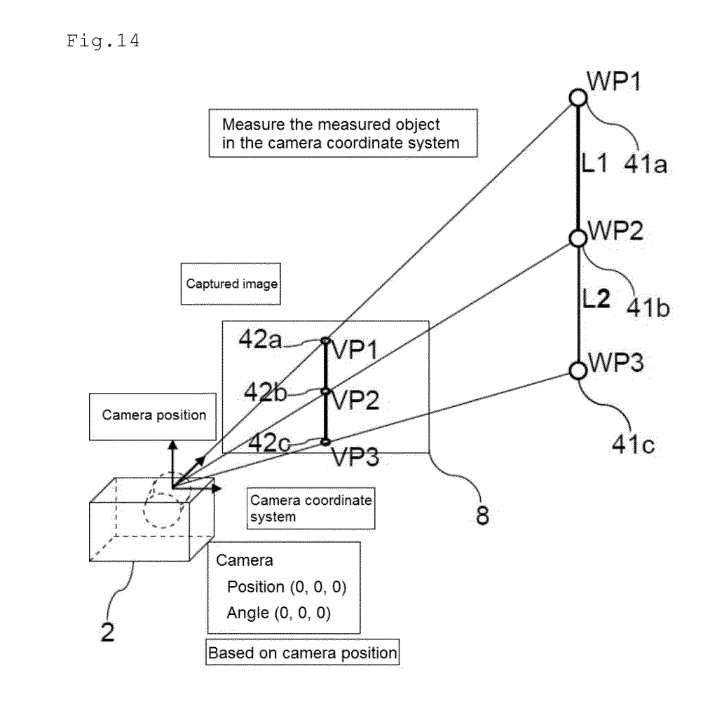

Specifically, distance-between-points data (L1 and L2) of three known points on a single straight line of a measured object such as shown in FIG. 14 are read.

### (2) Thereafter, Internal Orientation Parameters (Camera Parameters) of the Camera are Set.

The camera parameters for distortion correction of an image (lens) that have been measured in advance are set.

(3) View Coordinates (Camera Coordinates) of the Measured Object in the captured image are acquired.

From the captured image, distortion correction of the view coordinates of the measured object is performed and the view coordinates (VP1, VP2, and VP3) are acquired.

### (4) Coordinate Values of the Measured Object Based on the Camera are Acquired.

Three dimensional coordinates (WP1, WP2, and WP3) of the measurement positions when a central position of the camera is set as an origin are calculated from the view coordinates (VP1, VP2, and VP3) of the measured object and the distance-between-points (L1 and L2) of the three feature points.

A calculation method in the process of (4) above in the case where the three points are on the single straight line shall now be described in detail.

Let f be the focal distance of the camera, the origin be the camera center, and P′1 (X01, Y01, −f), P′2 (X02, Y02, −f), and P′3 (X03, Y03, −f) respectively be the camera coordinates of the three points. Then, with P0 as the origin, a plane made up of P0, P′1, and P′3, is defined. P′1, P′2, P′3 are on the single straight line and thus P′2 is also present on the defined plane.

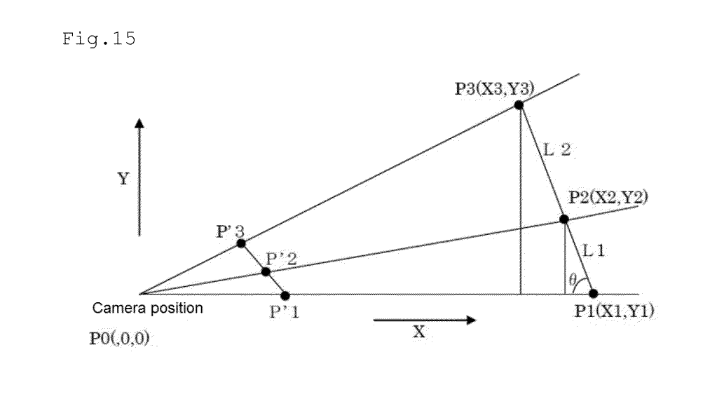

When as shown in FIG. 15, P1(X1, Y1), P2(X2, Y2), and P3(X3,Y3) are the actual coordinates of the three points on the plane and L1 and L2 are respectively the distance data between P1 and P2 and the distance data between P2 and P3, the following relationship holds.

When origin is the camera position, the straight line (P0-P′3) is expressed by the following Formula 1 with a as a slope. Also, the straight line (P0-P′2) is expressed by the following Formula 2 with b as the slope. Also, the following Formula 3 holds because the Y coordinate Y1 of the feature point P1 lies on the X-axis.

y=ax (Formula 1)

y=bx (Formula 2)

Y1=0 (Formula 3)

Here, if L0=L1+L2, the distance between the feature point P3 and the X-axis can be expressed by Formula 4 given below based on Formula 1 given above. Also, the distance between the feature point P2 and the X-axis can be expressed by Formula 5 given below based on Formula 2 given above.

L0 sin θ=a(X1−L0 cos θ) (Formula 4)

L1 sin θ=b(X1−L1 cos θ) (Formula 5)

Here, the unknowns are the two values of θ and X1. These two unknowns are solved from Formula 4 and Formula 5 given above.

The following Formula 6 is obtained by modifying Formula 4 given above. Also, the following Formula 7 is obtained by modifying Formula 5 given above.

X1=L0 sin θ/a+L0 cos θ (Formula 6)

X1=L1 sin θ/b+L0 cos θ (Formula 7)

X1 is eliminated from Formula 6 and Formula 7 to obtain Formula 8.

L0 sin θ/a+L0 cos θ=L1 sin θ/b+L1 cos θ (Formula 8)

The following Formula 9 is obtained by modifying Formula 8 given above.

(aL1−bL0)sin θ=ab(L0−L1)cos θ (Formula 9)

By then eliminating sine from Formula 9 given above because sin²θ+cos²θ=1 holds from a relationship of trigonometric functions, the following Formula 10 is obtained.

+/−√(1−cos² θ)=ab(L0−L2)cos θ/(aL1−bL0) (Formula 10)

By solving Numerical Formula 10 given above, and substituting the constants with A and B and letting t=cos θ as indicated in the following Numerical Formula 11, the following Formula 11 is obtained.

t=+/−√(A/B) (Formula 11)

Here,A=(aL1−bL0)×(aL1−bL0)

B=a²b²(L0−L1)²+A

t=cos θ

When this is substituted into Formula 6 and Formula 7 given above, the coordinates (X1, Y1) of the feature point P1 are expressed as shown in the following Formula 12. Also, from a geometrical relationship shown in FIG. 15, the coordinates (X2, Y2) of the feature point P2 are expressed as shown in Formula 13 below using the distance data L1 and the slope b. Also, the coordinates (X3, Y3) of the feature point P3 are expressed as shown in Formula 14 below using the distance data L0 (=L1+L2) and the slope a.

X1=L0√(1−t²)/a+L0t,Y1=0 (Formula 12)

X2=X1−L1t,Y2=b(X1−L1t) (Formula 13)

X3=X1−L0t,Y3=a(X1−L0t) (Formula 14)

The respective components in the XYZ directions of P′1, P′2, and P′3 are expressed by Formula 16 below using Formula 15 below.

L01=√(X01²+Y01²+f²),L02=√(X02²+Y02²+f²),L03=√(X03²+Y03²+f²) (Formula 15)

P′1=(X01/L01,Y01/L01,f/L01),P′2=(X01/L02,Y01/L02,f/L02),P′3=(X01/L03,Y01/L03,f/L03) (Formula 16)

The actual three-dimensional coordinates of the respective points P1, P2, and P3 are thus results of multiplying the distances P0-P1, P0-P2, and P0-P3, calculated from the planar coordinates (X1, Y1), (X2, Y2), and (X3, Y3), by the respective components, and the three-dimensional positions of P1, P2, and P3 in the camera-based coordinate system are thereby determined.

Although t may take on the two values of + and −, it can be understood that in actuality, the right hand side of Formula 10 above is positive and thus only one of either the + or −value is possible as the solution that depends on the sign of aL1−bL0.

### Embodiment 6

(Three-Dimensional Position Measurement Using Three Feature Points that are not Present on a Straight Line)

With Example 6, single camera image measurement processing using a measured object having three feature points that are not present on a straight line shall be described. Although depending on the level of accuracy, feature points that lie perfectly on a single straight line cannot be realized readily due to problems of manufacture, and thus the single camera image measurement processing using a measured object having such three feature points shall be disclosed below. As in Example 5 described above, the following processes (1) to (4) are performed in the present single camera image measurement processing.

### (1) Distance Data of the Measured Object are Read.

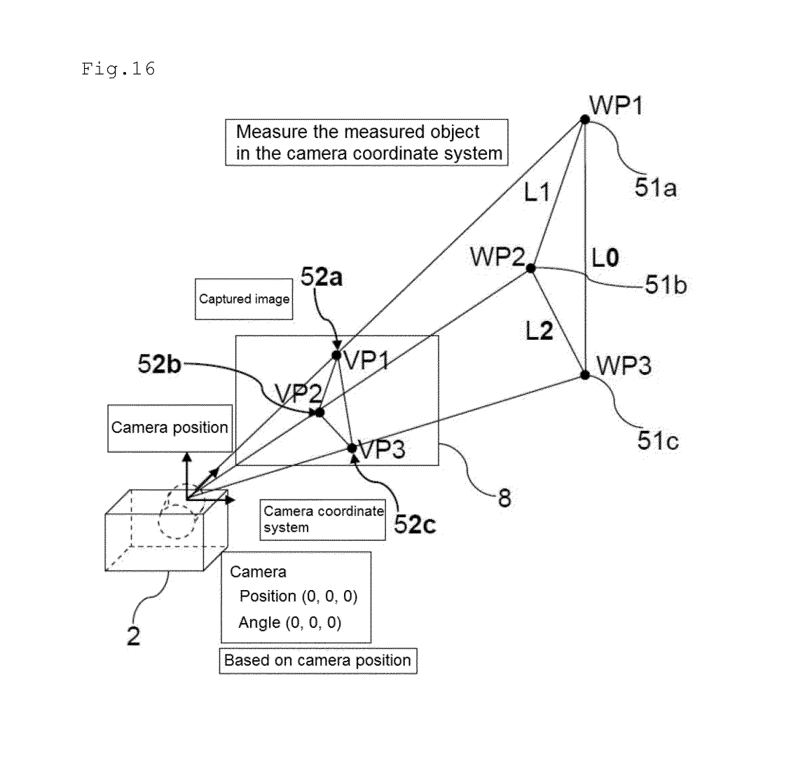

Specifically, distance-between-points data (L1 and L2) of three known points on a single straight line of a measured object such as shown in FIG. 16 are read.

### (2) Thereafter, the Internal Orientation Parameters (Camera Parameters) of the Camera are Set.

The camera parameters for distortion correction of an image (lens) that have been measured in advance are set.

### (3) View Coordinates (Camera Coordinates) of the Measured Object on the Captured Image are Acquired.

From the captured image, distortion correction of the view coordinates of the measured object is performed and the view coordinates (VP1, VP2, and VP3) are acquired.

### (4) The Coordinate Values of the Measured Object Based on the Camera are Acquired.

The three dimensional coordinates (WP1, WP2, and WP3) of the measurement positions when the central position of the camera is set as the origin are calculated from the view coordinates (VP1, VP2, and VP3) of the measured object and the distance-between-points (L1 and L2) of the three feature points.

A calculation method in the process of (4) above in the case where the three points are not present on the straight line shall now be described in detail.

Let f be the focal distance of the camera, the origin be the camera center, and P′1 (X01, Y01, −f), P′2 (X02, Y02, −f), and P′3 (X03, Y03, −f) respectively be the camera coordinates of the three points. Then, with P0 as the origin, planes H1 and H2, made up of P0, P′1, and P′2 and of P0, P′1, and P′3, respectively, are defined.

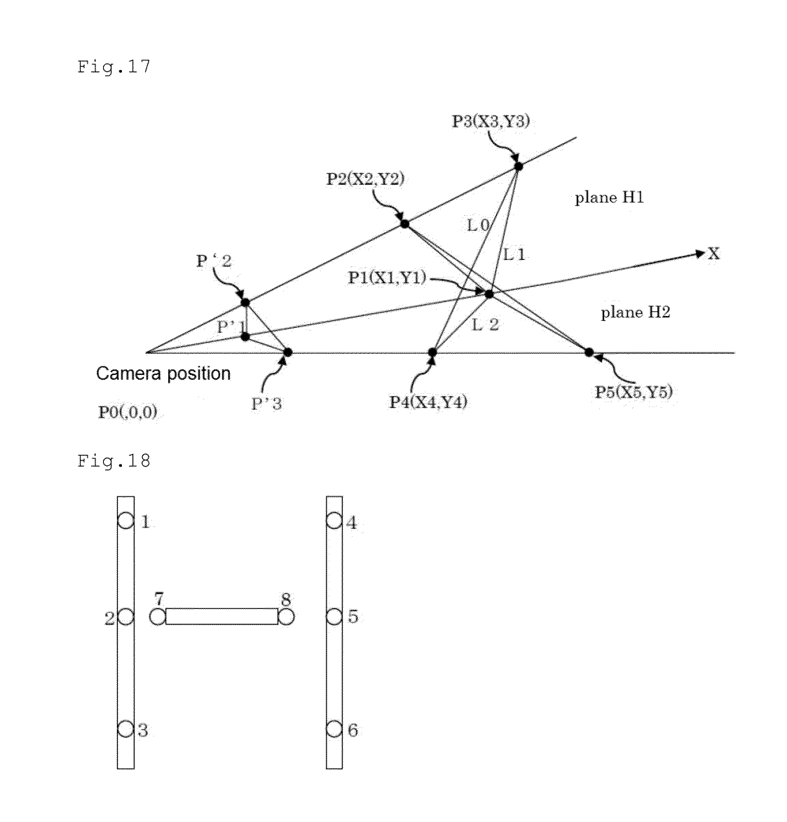

When, as shown in FIG. 17, L1, L2, and L0 (the longest side) are the respective actual lengths among the three points, P2 (X2, Y2) and P3 (X3, Y3) are points on the plane H1 that lie on P0-P′2 at the distance L1 from P1 (X1, Y1), and P4 (X4, Y4), and P5 (X5, Y5) are points on the plane H2 that lie on P0-P′3 at the distance L0 from P1 (X1, Y1), the following relationship holds.

When the origin is the camera position, the straight line (P0-P′3) is expressed, on the plane H1, by the following Formula 17 with a as a slope. Also, the straight line (P0-P′2) is expressed, on the plane H2, by the following Formula 18 with b as the slope. Also, the following Formula 19 holds because the Y coordinate Y1 of the feature point P1 lies on the X-axis.

y=ax (Formula 17)

y=bx (Formula 18)

Y1=0 (Formula 19)

Here, if X1 is known, P2, P3, P4, and P5 are expressed by the following Formula 20 to Formula 23.

X2=(X1−√t1)/(a²+1),Y2=aX2 (Formula 20)

X3=(X1−√t1)/(a²+1),Y3=aX3 (Formula 21)

X4=(X1−√t2)/(b²+1),Y4=bX4 (Formula 22)

X5=(X1−√t2)/(b²+1),Y5=bX5 (Formula 23)

Here,t1=X1²−(b²+1)×(X1²−L2²),

t2=X1²−(a²+1)×(X1²−L1²)

The distances S1 to S5 from the origin to the points P1, P2, P3, P4, and P5 are expressed by the following Formula 24 to Formula 28, respectively.

S1=×1 (Formula 24)

S2=√(X2²+Y2²) (Formula 25)

S3=√(X3²+Y3²) (Formula 26)

S4=√(X4²+Y4²) (Formula 27)

S5=√(X5²+Y5²) (Formula 28)

If (P′1x, P′1y, P′1z), (P′2x, P′2y, P′2z), (P′3x, P′3y, P′3z) are the vector components of P′1, P′2, P′3, respectively, the three-dimensional coordinates of the points P1, P2, P3, P4, and P5 can be expressed by the following Formulae.

X01=S1×P′1x

Y01=S1×P′1y

Z01=S1×P′1z

X02=S2×P′2x

Y02=S2×P′2y

Z02=S2×P′2z

X03=S3×P′2x

Y03=S3×P′2y

Z03=S3×P′2z

X04=S4×P′3x

Y04=S4×P′3y

Z04=S4×P′3z

X05=S5×P′3x

Y05=S5×P′3y

Z05=S5×P′3z

P1=(X01,Y01,Z01)

P2=(X02,Y02,Z02)

P3=(X03,Y03,Z03)

P4=(X04,Y04,Z04)

P5=(X05,Y05,Z05)

Also, the distance P2-P4 or P5 or the distance P3-P4 or P5 is L0, and thus the following four formulae of Formula 29 to Formula 32 hold.

L0²=(X02−X04)²+(Y02−Y04)²+(Z02−Z04)² (Formula 29)

L0²=(X02−X05)²+(Y02−Y05)²+(Z02−Z05)² (Formula 30)

L0²=(X03−X04)²+(Y03−Y04)²+(Z03−Z04)² (Formula 31)

L0²=(X03−X05)²+(Y03−Y05)²+(Z03−Z05)² (Formula 32)

Here, whether or not there is a position such that each distance is equal to L0 is determined by calculation by gradually increasing X1 from 0. The coordinates calculated on the plane are converted to three-dimensional coordinates in the same manner as in the case where the three points lie on a straight line. With this method, ordinarily, a plurality of solutions exists and in general, two solutions exist. However, by determining the positional relationships of the three feature points and the camera and comparing with the calculation results, the correct solution can be restricted to a single solution.

In consideration that the three points are positioned in substantially the same directions, the relative positional relationship of a straight line joining two points at both ends and a central point may be examined in advance, and the measurement result that matches the examined contents can be deemed to be the solution. That is, if the two points at both ends are directed toward a central direction of the camera, a single solution can be determined from such information as on which of front, rear, right, and left sides the central point is at with respect to the line joining the two points at both ends or how large the distance from the point to the straight line is, etc.

(Accuracy Verification Experiment 4)

In Accuracy Verification Experiment 4, as shown in FIG. 8, two bars, each of known length and having three points (points 1 to 3 or points 4 to 6) positioned on a straight line, were disposed at right and left sides, a scale bar (point 7 and point 8) was disposed at a central portion, and the measurement targets (feature points 1 to 8) were measured using a camera with the specifications shown below. Distances between respective points of the measurement targets (feature points 1 to 8) that were measured in advance are indicated in Table 10 below.

Also, the camera view coordinates (x, y) of the measurement targets (feature points 1 to 8) are indicated in Table 11 below. Retroreflective markers were used as the measurement targets (feature points 1 to 8). The units of length in the Tables are millimeters (mm).

(Camera Specifications)
Model No.: Nikon DX2, number of pixels: 12 million pixels
Internal orientation parameters
a) Focal distance: 28.9670
b) Pixel length: 0.00552
c) Deviation of principal point: xp=0.2212, yp=−0.1177
d) Distortion coefficients:
   Radial
      k1=8.5604E-05
      k2=−1.2040E-07
      k3=−9.3870E-14
   Tangential
      p1=8.9946E-06
      p2=−3.5178E-06

With each of the sets of three points (points 1 to 3 and points 4 to 6) of known length at the right and left side, the point at the center (point 2 or point 5) is positioned approximately 0.2 to 0.3 mm away in a depth direction from a line joining the points at the single portions. The projected points of the points on a straight line are thus positioned closer to the camera side than the points themselves. Z has a negative value, and if a Z-coordinate of the projected point minus Z-coordinate of the central point is the “depth,” a negative depth value indicates that the point is closer to the camera side than the straight line, and if the depth value is positive, the point is positioned behind the straight line as viewed from the camera.

TABLE 10

| Two | Distance between two | Two | Distance between two |
|---|---|---|---|
| points | points (mm) | points | points (mm) |
| 1 - 3 | 758.0890 | 4 - 6 | 756.7966 |
| 1 - 2 | 321.6892 | 4 - 5 | 304.3274 |
| 2 - 3 | 436.4014 | 5 - 6 | 452.4695 |
| 1 - 7 | 453.4745 | 4 - 8 | 422.3718 |
| 7 - 3 | 382.8619 | 8 - 6 | 407.5723 |

TABLE 11

| | Camera | Camera | | Camera | Camera |
|---|---|---|---|---|---|
| | view | view | | view | view |
| | X | Y | | X | Y |
| Point | coordinates | coordinates | Point | coordinates | coordinates |
| 1 | −6.7621 | 5.3922 | 4 | 6.5395 | 5.1813 |
| 2 | −6.9480 | 1.0108 | 5 | 6.7362 | 1.0215 |
| 3 | −7.2230 | −5.3609 | 6 | 7.0621 | −5.6174 |
| 7 | −4.4409 | −0.3697 | 8 | 4.3043 | −0.1878 |

(A) Case of using three points (point 1, point 2, and point 3) positioned on a single straight line and three points (point 4, point 5, and point 6) positioned on a single straight line

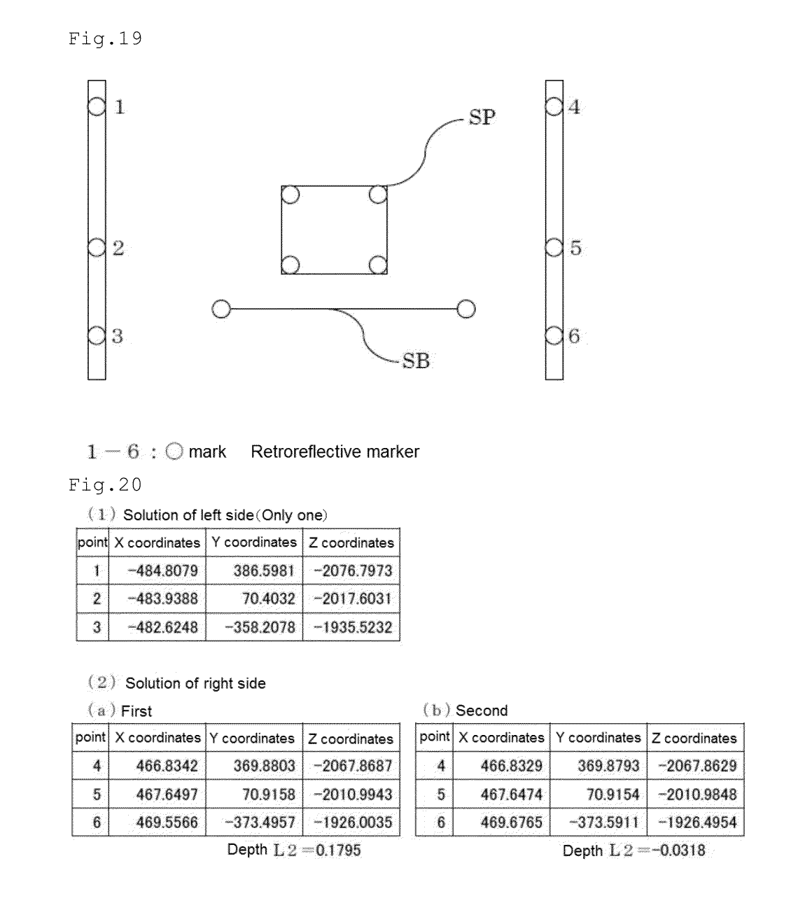

The processes described above with Example 5 were performed to calculate the three-dimensional coordinates based on the camera. The results are shown in FIG. 20. In the camera image, only one solution was calculated for the three points (point 1, point 2, and point 3) at the left side. On the other hand, two solutions were calculated for the three points (point 4, point 5, and point 6) at the right side. With L2 being the distance from a point, formed by projecting the point 5 onto a line joining the point 4 and the point 6, to the camera center and L4 being the distance from the point 5 to the camera center, the depth (=L2-L4) was determined.

With the three points (point 4, point 5, and point 6) at the right side for which two solutions were obtained, the depth value determined for the first solution was 0.1795 and that for the second solution was −0.0318.

It is known that in the camera image, the central point 5 among the three points (point 4, point 5, and point 6) at the right side is located approximately 0.3 mm closer to the camera center than the line joining the point 4 and the point 6, and thus the second solution, with which the depth value becomes negative, is the correct solution.

Based on the above, the distances between two points of point 1-point 4 and point 3-point 6 were calculated, and the calculated values and the actually measured values of the camera-based distances were compared to determine errors. The results are shown in Table 12.

TABLE 12

| Two | Calculated | Actually measured | Error |
|---|---|---|---|
| points | value (mm) | value (mm) | (mm) |
| 1 - 4 | 951.912 | 951.830 | −0.082 |
| 3 - 6 | 952.503 | 952.468 | −0.035 |

From the above Table 12, it can be understood that the error is extremely small and application to actual measurement is possible.

(B) Case of using three points (point 1, point 7, and point 3) not present on a straight line and three points (point 4, point 8, and point 6) not present on a straight line

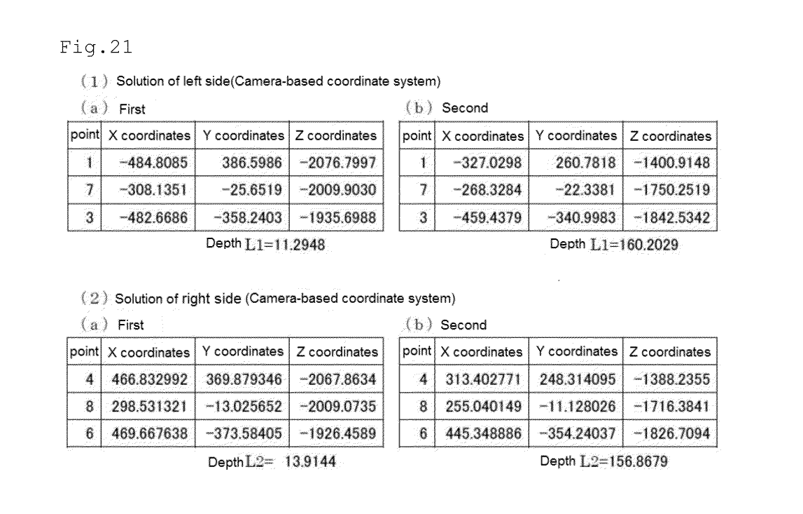

The processes described above with Example 6 were performed to calculate the three-dimensional coordinates based on the camera. The results are shown in FIG. 21. In the camera image, two solutions were calculated for the three points (point 1, point 7, and point 3) at the left side. Two solutions were also calculated for the three points (point 4, point 8, and point 6) at the right side. With L1 being the distance from a point, formed by projecting the point 2 on a line joining the point 1 and the point 3, to the camera center and L3 being the distance from the point 2 to the camera center, the depth (L1-L3) was determined. Also, with L2 being the distance from a point, formed by projecting the point 5 on a line joining the point 4 and the point 6, to the camera center and L4 being the distance from the point 5 to the camera center, the depth (L2-L4) was determined.

Although two solutions were obtained for both the right side and left side, it can be understood from a comparison of the depth values that the smaller of the values is the correct solution for both sides.

Based on the above, the distances between two points of point 1-point 4, point 3-point 6, and point 7-point 8 were calculated, and the calculated values and the actually measured values of the camera-based distances were compared to determine errors. The results are shown in Table 13.

TABLE 13

| Two | Reference | Actually measured | Error |
|---|---|---|---|
| points | value (mm) | value (mm) | (mm) |
| 1 - 4 | 951.9120 | 951.8303 | −0.0817 |
| 3 - 6 | 952.5020 | 952.5047 | 0.0018 |
| 7 - 8 | 606.8000 | 606.7983 | −0.0017 |

(Accuracy Verification Experiment 5)

In Accuracy Verification Experiment 5, as shown in FIG. 19, two bars, each of known length and having three points (points 1 to 3 or points 4 to 6) positioned on a straight line, were disposed at right and left sides, and after measuring the three-dimensional positions of the respective points in accordance with Example 5 above, the length of a scale bar SB of known length was measured in each of two images. Also in the same camera images, the length of the same scale bar SB was measured in each of two images using a reference plate SP in which four points are positioned, to compare measurement errors.

Retroreflective markers were used as the measurement targets (feature points 1 to 6). The units of length in the Tables are millimeters (mm).

(Camera Specifications)
Model No.: Nikon DX2, number of pixels: 12 million pixels
Internal orientation parameters
a) Focal distance: 28.9695
b) Pixel length: 0.00552
c) Deviation of principal point: xp=0.1987, yp=−0.1300
d) Distortion coefficients:
   Radial
      k1=8.5244E-05
      k2=−1.196E-07
      k3=4.4477E-12
   Tangential
      p1=1.0856E-05
      p2=−4.0565E-06

With each of the sets of three points (points 1 to 3 and points 4 to 6) of known length at the right and left side, the point at the center (point 2 or point 5) is positioned approximately 0.2 to 0.3 mm away in a depth direction from a line joining the points at the single portions. The projected points of the points on a straight line are thus positioned closer to the camera side than the points themselves. Z has a negative value, and if Z-coordinate of the projected point minus Z-coordinate of the central point is the “depth,” a negative depth value indicates that the point is closer to the camera side than the straight line, and if the depth value is positive, the point is positioned behind the straight line as viewed from the camera. The distances between the respective points are shown in Table 14.

TABLE 14

| Two points | Distance (mm) | Two points | Distance (mm) |
|---|---|---|---|
| 1 - 3 | 812.83098 | 4 - 6 | 805.7319 |
| 1 - 2 | 543.17521 | 4 - 5 | 536.7262 |
| 2 - 3 | 269.656 | 5 - 6 | 269.0059 |

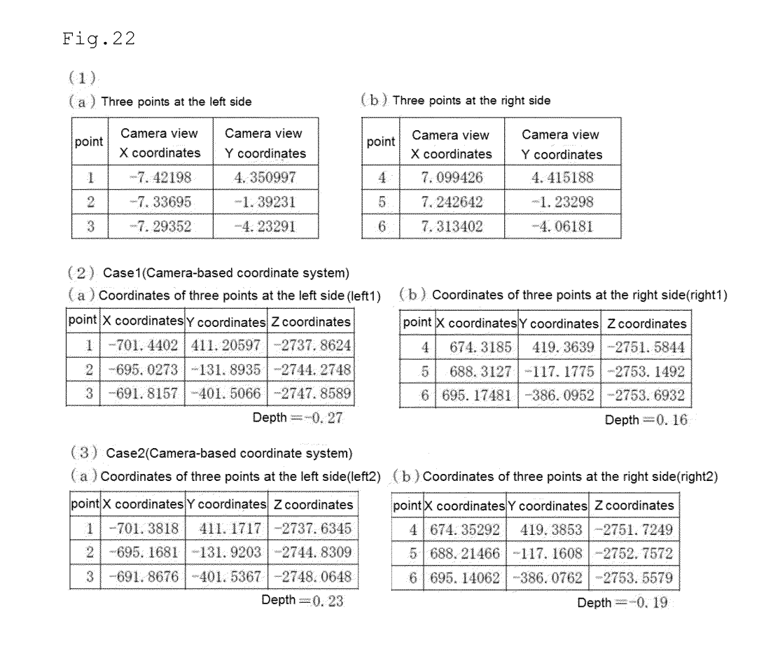

As in Accuracy Verification Experiment 4 described above, two solutions exist for each side in terms of calculation. The processes described with Example 5 above were performed to calculate the three-dimensional coordinates based on the camera. The results are shown in FIG. 22. The correct solutions are a combination with which the depths take on positive values, and thus the correct solution is that of Case 2 for the left side and that of Case 1 for the right side.

Next, results of capturing two images from the right and left and calculating the dimension of the scale bar SB using the four points of the reference plate SP (four-point plate) and calculating the dimension of the scale bar SB using three points using the method of Example 5 (three-point measurement) are shown in Table 15 below. For calculation, a two image measurement method using no less than four reference points, which is disclosed in a prior patent document (Japanese Patent Application No. 2009-97529), was performed.

TABLE 15

| | Scale bar | Calculated value | Error |
|---|---|---|---|
| Four-point plate | 1114.8 | 1114.7132 | −0.087 |
| Three-point measurement | 1114.8 | 1114.7271 | −0.073 |

Also, for the sake of reference, all of the results of calculating using combinations of the total of four solutions are shown in Table 16.

TABLE 16

| Case | Calculated value | Error |
|---|---|---|
| Case 1 (Left 1 - Right 1) | 1114.6903 | −0.110 |
| Case 2 (Left 1 - Right 2) | 1114.6632 | −0.137 |
| Case 3 (Left 2 - Right 1) | 1114.7271 | −0.073 |
| Case 4 (Left 2 - Right 2) | 1114.6999 | −0.100 |

### INDUSTRIAL APPLICABILITY

The single camera image measurement processing apparatus, image measurement processing method, and image measurement processing program according to the present invention are useful for a system using a single camera to recognize a three-dimensional position of an object on a production line, position an object, or track an object, etc.

These are also useful for making three-dimensional measurements of a measured object using a contacting type or non-contacting type measuring probe.

### DESCRIPTION OF SYMBOLS

1 Single camera image measurement processing apparatus
2 Digital camera
3 Information computing terminal (Note type PC)
4 Data transfer cable
5 Camera field of view
6, 7 Measured object
8 Camera image
9 Feature points in a camera image
20 Measuring probe
21, 22, 23, 24 Feature points
25 Probe
27 Point laser light
29 Line laser light
30 Continuous line
T1-T8 Feature points
SB Scale bar
SP Reference plate

1. A single camera image measurement processing apparatus comprising:
a single camera means; and
an information computing terminal including at least a computing means, a storage means, and a data transfer means; and
wherein, in the information computing terminal,
the storage means
stores, in advance, calculated internal orientation parameters of the camera means and distance-between-points data of three feature points of a measured object (with the three points being present on a single straight line and there being no other restrictions),
the data transfer means
loads at least one image captured using the camera means and containing the three feature points within a camera field of view, and
the computing means
performs, on camera view coordinates of the feature points in the loaded image, correction, based on the internal orientation parameters, of distortion in the image and
calculates, from the camera view coordinates of the distortion-corrected feature points and the distance-between-points data of the three feature points, three-dimensional coordinates of the three feature points in a camera-based coordinate system.

2. A single camera image measurement processing method for performing photogrammetry of a measured object using a single camera means, the method comprising:
a step of reading distance-between-points data of three feature points of the measured object (with the three points being present on a single straight line and there being no other restrictions);
a step of reading internal orientation parameters of the camera means;
a step of loading at least one image captured using the camera means and containing the three feature points within a camera field of view;
a step of performing, on camera view coordinates of the feature points in the loaded image, correction, based on the internal orientation parameters, of distortion in the image; and
a three-point-on-single-straight-line actual coordinate calculating step of calculating, from the camera view coordinates of the distortion-corrected feature points and the distance-between-points data of the three feature points, three-dimensional coordinates of the three feature points in a camera-based coordinate system.

3. A storage means (hard disk and/or memory) storing a single camera image measurement processing program for performing photogrammetry of a measured object using a single camera means, the program making a computer execute:
1) a procedure of reading distance-between-points data of three feature points of a measured object (with the three points being present on a single straight line and there being no other restrictions);
2) a procedure of reading internal orientation parameters of the camera means;
3) a procedure of loading at least one image captured using the camera means and containing the three feature points within a camera field of view;
4) a procedure of performing, on camera view coordinates of the feature points in the loaded image, correction, based on the internal orientation parameters, of distortion in the image;
5) a procedure of calculating, from the camera view coordinates of the distortion-corrected feature points and the distance-between-points data of the three feature points, three-dimensional coordinates of the three feature points in a camera-based coordinate system; and
6) a procedure of repeating the above 3) to 5).

4. A video camera having the single camera image measurement processing program according to claim 3 installed therein.
